(19) United States
(12) Patent Application Publication
(10) Pub. No.: US 2016/0060492 A1
(43) Pub. Date: Mar. 3, 2016

(54) PROTECTION OF NEW ELECTRO-CONDUCTORS BASED ON NANO-SIZED METALS USING DIRECT BONDING WITH OPTICALLY CLEAR ADHESIVES

(71) Applicant: 3M INNOVATIVE PROPERTIES COMPANY, St. Paul, MN (US)

(72) Inventors: Ying Zhang, Woodbury, MN (US); Albert I. Everaerts, Oakdale, MN (US); Corrine Lipscomb, St. Paul, MN (US)

(21) Appl. No.: 14/474,958

(22) Filed: Sep. 2, 2014

(51) Int. Cl. C09J 133/08; C08K 5/11; C08K 5/50; C08K 5/07; C08K 5/13; C08K 5/01; C08K 5/05; B32B 37/12; C08K 5/09

(52) U.S. Cl. CPC C09J 133/08; B32B 37/12; C08K 5/11; C08K 5/50; C08K 5/09; C08K 5/13; C08K 5/01; C08K 5/05; C08K 5/07; B32B 2457/00

(57) ABSTRACT

The present invention is an adhesive composition for stabilizing an electrical conductor. The adhesive composition includes a base polymer and an additive to interfere with photo-oxidation of metals. When the adhesive composition is in contact with the electrical conductor, the electrical conductor has less than about a 20% change in electrical resistance over a period of about 500 hours of light exposure.

### FIELD OF THE INVENTION

The present invention is related to optically clear adhesive compositions. In particular, the present invention is related to optically clear adhesive compositions that can stabilize electrical conductors.

### BACKGROUND

Over the past few decades, transparent, electro-conductive films have been used extensively in applications such as touch panel displays, liquid crystal displays, electroluminescent lighting, organic light-emitting diode devices, and photovoltaic solar cells. Indium tin oxide (ITO) based transparent conductive films have been the choice for most applications. However, ITO based transparent conductive films have limitations due to high cost, the need for complicated and expensive equipment and processes, relatively (vs. pure metal) high resistance, and inherent brittleness and tendency to crack; especially when deposited on flexible substrates. New conductors based on metallic nanoparticles, nanorods, and nanowires have seen significant technical advances in recent years and printed patterns, randomized patterns (to minimize visibility and Moire), and metal meshes (derived from nano-sized metallic material) have become much more attractive to the electronics industry. Metallic conductors based on silver and copper are perhaps the most common. Particular examples are silver nanowires (SNWs). SNW-based films impart high conductivity, high optical transmission, superior flexibility and ductility at a moderate cost, which make them a desirable alternative for ITO in many applications; especially for thinner and more flexible devices.

However, it is very challenging to keep SNWs stable for long periods of time because they can be sensitive to light and environmental exposure. One such example is the UV induced degradation of the conductive traces of a SNW-based touch panel in the viewing area of a display and/or near the ink edge (the black or white ink border around the display). This degradation can result in a sudden loss of conductivity and thus also a loss of touch panel function, possibly due to photo-oxidation of the SNW. Some of the literature suggests that the so-called plasmon resonance of silver can facilitate silver oxidation to silver oxide.

### SUMMARY

In one embodiment, the present invention is an adhesive composition for stabilizing an electrical conductor. The adhesive composition includes a base polymer and an additive to interfere with photo-oxidation of metals. When the adhesive composition is coated on the electrical conductor, the electrical conductor has less than about a 20% change in electrical resistance over a period of about 500 hours of light exposure.

In another embodiment, the present invention is a method of stabilizing an electrical conductor. The method includes providing an adhesive composition and coating the adhesive composition on the electrical conductor. The adhesive composition includes a base polymer and an additive for interfering or preventing oxidation of the electrical conductor. When the adhesive composition is coated on the electrical conductor, the electrical conductor has less than about a 20% change in electrical resistance over a period of about 500 hours of light exposure.

### BRIEF DESCRIPTION OF THE DRAWINGS

FIG. 1A is a top view of a sample construction for measuring the change in electrical resistance of a silver nanowire film.

FIG. 1B is a side view of the sample construction shown in FIG. 1A for measuring the change in electrical resistance of a silver nanowire film

These figures are not drawn to scale and are intended merely for illustrative purposes.

### DETAILED DESCRIPTION

The present invention is an optically clear adhesive (OCA) composition that provides stability to nanowire sensors under various conditions even without ultraviolet (UV) or visible light protection coatings. The optically clear adhesive composition includes a base polymer and additives that interfere with photo-oxidation of metals. The base polymer can be selected from any optically clear adhesive polymer. Examples of suitable additives include anti-oxidants, complexing agents for metals, reducing agents, materials that are both reducing and complexing with the metals, and combinations thereof. The OCAs of the present invention can stabilize electrical conductors based on metallic nanoparticles, nanorods, and nanowires used, for example, in touch screens, electromagnetic shielding, photovoltaic panels, metal meshes, transparent heating wire patterns for windows, etc. When exposed to UV and visible light, these metallic conductors may be susceptible to degradation, causing a loss in conductivity. By applying the OCAs of the present invention directly on the conductor, costly protective coatings (i.e., barriers, UV blocking) can be avoided and the assembly process of the articles can be simplified. The present invention also covers methods of use and articles containing such OCAs in contact with the metallic conductors.

The optically clear adhesive compositions of the present invention may be pressure-sensitive or heat-activatable in nature. Likewise, they can be applied as a film adhesive, directly dispensed as a hot melt, or applied as a liquid OCA and cured in the final assembly.

The adhesive composition of the present invention includes a base polymer. While adhesive compositions derived from an acrylic base polymer, and in particular, a random (meth)acrylic copolymer, are preferred because of their moderate cost and wide availability, other polymers can also be used as the matrix for the adhesive composition without departing from the intended scope of the present invention. Examples of other polymers include, but are not limited to: polyesters, polyurethanes, polyureas, polyamides, silicones, polyolefins, acrylic block copolymers, rubber block copolymers (i.e., polystyrene—polyisoprene-polystyrene (SIS), polystyrene—poly(ethylenebutylene)-polystyrene (SEBS), polystyrene—poly(ethylenepropylene)-polystyrene (SEPS), etc.), and combinations thereof. Where optically clear blends are obtained, mixtures of these polymers (including the (meth)acrylates) can also be used.

The polymers may be commercially available or they can be polymerized by conventional means, including solution polymerization, thermal bulk polymerization, addition polymerization, ring-opening polymerization, emulsion polymerization, UV or visible light triggered bulk polymerization, and condensation polymerization.

The adhesive composition of the present invention also includes at least one additive that interferes with photo-oxidation. The additives function to either interfere or prevent oxidation of the metallic conductors when exposed to UV light. Suitable additives are thus those that interfere with photo-oxidation of metals. Examples of suitable additives that interfere with photo-oxidation of metals include, but are not limited to: metal complexing materials, anti-oxidants, reducing agents, metal complexing and reducing materials and combinations thereof.

Metal complexing agents are materials that can migrate to the surface of the metallic conductor and form a complex with the surface that binds the agent to the surface. Without being bound by theory, it is believed that in the process of doing so, the additive may prevent the access of moisture and oxygen to the metal interface, reducing or eliminating the risk of dissolving away any oxidized species. Examples of suitable complexing agents include, but are not limited to, carboxylic acids such as hydro cinnamic acid or citrates. Natural compounds such as ascorbic acid may also be used, provided that it is soluble in the adhesive matrix.

Anti-oxidants function to interfere with photochemically initiated degradation reactions and thus inhibit the oxidation of the electrical conductors. While anti-oxidants are known to interfere with the oxidation process, they have not previously been known in the art to be used in combination with readily oxidizable metallic conductors, such as nanoparticles, nanorods or nanowires. Examples of suitable anti-oxidants are those sold under the tradename Irganox (i.e., Irganox 1010, Irganox 1024 and Irganox 1076), available from BASF located in Florham Park, N.J. or Cyanox from CYTEC located in Woodland Park, N.J. Natural anti-oxidants such as ascorbic acid may also be used, provided that it is soluble in the adhesive matrix.

Reducing agents can interfere with oxidation of the metal conductor in at least two ways. The reducing agents can react with the oxygen species that are oxidizing the metal to a metal oxide and/or they can very quickly reduce the metal oxide back to the metal state so the metal is preserved and the metal oxide cannot be dissolved and removed from the metal, resulting in maintenance of the electrical conductance. Without being bound by theory, it is thought that in some cases, these compounds preferentially adsorb on the metal surface, making them perhaps even more effective as reducing agents. Additional examples of suitable reducing agents include compounds that are organic molecules with relatively low oxidation potential, such as phosphines and unsaturated and polyunsaturated acids, etc. Examples include, but are not limited to: linoleic acid, oleic acid, linolenic acid, cinnamic acid, cinnamoyl alcohol, geraniol, citronellol, citronellal, citral, and cinnamaldehyde. Terpenes such as pinene and limonene can also be used. Unsaturated rosin acid and rosin acids, such as abietic acid may also be used. In some cases, the reducing agent may be copolymerized. An example of a suitable copolymerizing additive is citronellylacrylate.

Metal complexing and reducing materials function as a metal complexing material and a reducing agent, as described above. Compounds having carboxylic acid groups may be one such type of material and are suitable for use in the adhesive composition of the present invention. Examples of suitable metal complexing and reducing materials include, but are not limited to unsaturated and polyunsaturated acids, such as linoleic acid, oleic acid, linolenic acid, and cinnamic acid.

The minimal amount of additive required in the adhesive composition depends on the environmental exposure conditions and the amount of change in electrical resistance that will be tolerated. In one embodiment, the additives are present in the adhesive composition at about 5% by weight or less of the dry adhesive coating. In one embodiment, the additives are present in the adhesive composition at least at about 0.1% by weight. In one embodiment, the additives are present in the adhesive composition at between about 0.5 and about 3% by weight.

The additive significantly improves the stability of the conductors when in contact with the optically clear adhesive, even under quite harsh light exposure. Stability is measured by change in electrical resistance over a given period of time. Without being bound by theory, it is believed that stabilization interferes with the photo-oxidation process. In one embodiment, the resistance of the electrical conductor coated or laminated with the adhesive composition of the present invention will have a change in resistance of less than about 20%, particularly less than about 10% and more particularly less than about 5% over a period of about 3 weeks (500 hours).

When the adhesive composition must be optically clear, the additives should be miscible in the adhesive matrix so as to result in minimal to no impact on the optical properties of the adhesive composition so that the final formulation retains its optical clear property. “Optically clear” means having a high visible light transmission of at least about 90%, a low haze of no more than about 2% while also being color neutral and non-whitening. However, in some cases, such as with diffuse adhesives, the optical requirements may not be as stringent. While the adhesive composition is described primarily as an optically clear adhesive throughout this specification, the same additives may also be used in photo-resists that directly contact with the metallic conductor for example, or as part of the nano-sized metal particle dispersion itself, such as a silver nanowire ink.

The additives must also have no effect on the mechanical durability of the display assembly using the adhesive composition. In one embodiment, the adhesive composition has a 180 degree peel force of over at least about 30 oz/inch, particularly over at least about 40 oz/inch and more particularly over at least about 50 oz/inch after a 20 minute or a 72 hour dwell time. The additives should also be soluble in the adhesive matrix.

Depending on the manufacturing process used to make the adhesive composition, the additives may also be required to be compatible with the polymerization, coating, and curing processes used to produce the adhesive composition. For example, there must not be significant retardation or interference with the UV polymerization or curing process. In some embodiments, the additives must also be non-volatile in a solvent or hot melt coating process.

In one embodiment, in order to improve environmental durability, the adhesive composition may include a crosslinker. The polymers of the adhesive composition may be crosslinked using methods well-known in the art, including, for example, physical crosslinking (like high Tg grafts or blocks, hard segments, small crystallites, etc.), ionic crosslinking (such as carboxylic acid with a metal ion or acid./base type crosslinking), and covalent crosslinking (such as multifunctional aziridine with carboxylic acids, melamine with carboxylic acid, copolymerization of multifunctional (meth) acrylates, and hydrogen abstraction mechanism, such as with benzophenone or anthraquionone compounds).

The present invention addresses a rapidly emerging need for protecting new electro-conductors derived from nano-sized metals, such as silver and copper. The combination of the base polymer with the additives that interfere with photo-oxidation of metals not only provide environmental protection to these conductors, but most of them are also compatible with UV curing processes, including those used for liquid OCAs, some photoresists that may be used in patterning of the conductors, and the one-web polymerization process used in production of OCAs.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following example are on a weight basis.

Materials: Materials Used were Obtained from the Suppliers Listed Below.

| Chemical names | Suppliers | Supplier address |
|---|---|---|
| 2-EHA: 2-ethylhexyl acrylate | BASF | 100 Park Avenue, Florham Park, NJ 07932, USA |
| iBOA: Isobornyl acrylate | San Esters | 55 East 59^{th} Street, 19^{th} Floor, New York, NY 10022 |
| HEA: 2-Hydroxy ethyl acrylate | BASF | 100 Park Avenue, Florham Park, NJ 07932, USA |
| Vazo 52: 2,2′-Azobis(2,4- | Dupont | 1007 Market Street, Wilmington, DE 19898 |
| dimethylvaleronitrile) | | |
| Desmodur N-3300: aliphatic | Bayer | 100 Bayer Road, Pittsburgh, PA 15205-9741, USA |
| polyisocyanate | | |
| KBM-403: 3-glydidoxypropyl | Shin-Etsu | 611 West 6th Suite 2710, Los Angeles CA, 90017 |
| triethoxysilane | | |
| Acetyltri-2-ethyl-hexyl citrate | PFIZER | 235 East 42nd Street, New York, NY 10017 |
| Triphenyl phosphine | Alfa Aesar | 30 Bond Street, Ward Hill, MA 01835-8099 |
| Hydrocinnamic acid (H-cinnamic | Aldrich | 3050 Spruce Street, Saint Louis, MO 63103, USA |
| acid) | | |
| Irganox 1076 | BASF | 100 Park Avenue, Florham Park, NJ 07932, USA |
| Irganox 1024 | BASF | 100 Park Avenue, Florham Park, NJ 07932, USA |
| beta-Pinene | Aldrich | 3050 Spruce Street, Saint Louis, MO 63103, USA |
| Cinnamyl alcohol | Aldrich | 3050 Spruce Street, Saint Louis, MO 63103, USA |
| Cinnamaldehyde | Aldrich | 3050 Spruce Street, Saint Louis, MO 63103, USA |
| Cinnamic acid | Aldrich | 3050 Spruce Street, Saint Louis, MO 63103, USA |
| Linolenic acid | TCI America | 13135 N Woodrush Way, Portland, OR, US, 97203 |
| Rosin acid (non-hydrogenated) | Alfa Aesar | 30 Bond Street, Ward Hill, MA 01835-8099 |
| β-Citronellol | Aldrich | 3050 Spruce Street, Saint Louis, MO 63103, USA |
| Triethylamine | Aldrich | 3050 Spruce Street, Saint Louis, MO 63103, USA |
| Acryloyl chloride | Aldrich | 3050 Spruce Street, Saint Louis, MO 63103, USA |
| RF 22N release liner | SKC Haas | 12F Union Steel Bldg., 890 Daechi-dong, Kangnam-gu, |
| | | Seoul 135-524, Korea |
| RF 02N release liner | SKC Haas | 12F Union Steel Bldg., 890 Daechi-dong, Kangnam-gu, |
| | | Seoul 135-524, Korea |
| Primed PET, Skyrol SH81 | SKC Inc. | 863 Valley View Road |
| | | Eighty Four, PA 15330-9613 |
| 1,6-Hexanediol diacrylate (HDDA) | BASF | 100 Park Avenue, Florham Park, NJ 07932, USA |
| Irgacure 651 | BASF | 540 White Plains Road, P.O. Box 2005 |
| | | Tarrytown, NY 10591-9005 |
| Darocur 1173 | BASF | 540 White Plains Road, P.O. Box 2005 |
| | | Tarrytown, NY 10591-9005 |

### Preparation of Test Coupons

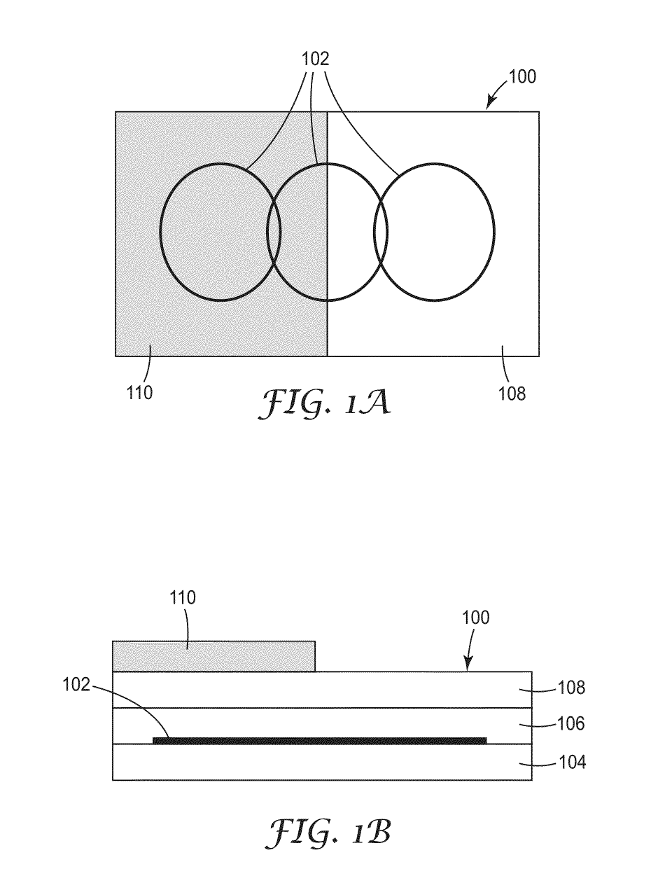

FIGS. 1A and 1B show top and side views, respectively, of test coupons 100 which represent a sample construction for measuring the change in electrical resistance of a silver nanowire film. Silver nanowires 102 (SNW) were created by coating silver ink (Cambrios Technologies Corporation, Sunnyvale, Calif.) on polyester (PET) film 104. The coating sheet resistance was typically about 50 Ohm/sq. The release liner was removed from one side of a 2 inch by 3 inch piece of optically clear adhesive (OCA) strip 106 and the OCA strip was placed in direct contact with the side of the PET film 104 coated with silver nanowires 102. The OCA strip 106 was secured with four passes of a small rubber hand roller, making sure no air bubbles were entrapped between OCA 106 and SNW coating 102. The second liner was removed from the OCA and the OCA/silver nanowire film assembly was laminated onto a 2 inch by 3 inch glass microscope slide 108. As shown in FIG. 1, half of the glass slide 108 opposite the OCA/silver nanowire film assembly was covered with black electrical tape 110 and the other half was left open. The test coupon 100 was irradiated with a xenon arc lamp from the side covered with the tape, so light either passed through the glass or was blocked by the black tape 110.

### Methods

### Method for Measuring Silver Nanowire Film Resistance Change

The resistance change was measured in each of the three different circled areas of the test coupon using a Delcom 707 Conductance Monitor (Delcom Instruments, Inc., Minneapolis, Minn.) and testing results are summarized in Tables 1-5. In Tables 1-5, measurements of the silver nanowire fully covered by the black electrical tape are referred to as “dark”, measurements of the silver nanowire partially covered by the black electrical tape are referred to as “interface”, and measurements of the silver nanowire fully exposed to the xenon arc lamp are referred to as “light”. Each circle was measured at least twice. If the measurements were in disagreement, the data was typically rejected and a new coupon was tested. A resistance change of less than 25% in 500 hours of exposure was considered acceptable performance. The “dark” measurement was made as an internal control to ensure there was no adverse interaction of the OCA film with the silver nanowire in absence of xenon arc lamp exposure. A resistance change greater than 25% in any of the “dark”, “interface” or “light” measurement areas was considered a failure of that test coupon. Blank cells in the tables mean that no data were collected.

The percent resistance change versus xenon arc lamp exposure time was calculated as follows: % resistance change=1/(100*(Gₜ−G₀)/G₀), where G₀ was the initial conductance without xenon arc lamp exposure and Gₜ was the conductance after t hours xenon arc lamp exposure. The parameters of the xenon arc lamp exposure conditions were as follows:

The xenon arc lamp exposure condition A parameters were: irradiance 0.4 W/m² at 340 nm, 60° C. black panel temperature, 38° C. air temperature, 50% relative humidity.

The xenon arc lamp exposure condition B parameters were: for the first 300 hours, samples were exposed under conditions of irradiance 0.4 W/m² at 340 nm, 60° C. black panel temperature, after that the samples were additionally exposed under conditions of irradiance 0.55 W/m² at 340 nm, 70° C. black panel temperature, 47° C. air temperature, 50% relative humidity.

### Method for Haze Measurement

Haze was measured according to ASTM D 1003 92. The results for Adhesive Example 13 are summarized in Table 6. Test specimens were prepared by cleaning LCD glass three times with isopropyl alcohol and completely drying it with KIMWIPES (Kimberly-Clark Corp., Neenah, Wis.). Each OCA film was cut to a size large enough to cover the entrance port of the sphere. The release liner was removed from one side and the OCA film was laminated onto the LCD glass with four passes of a small rubber hand roller. The sample was inspected visually to ensure it was free of visible distinct internal voids, particles, scratches, and blemishes. The second liner was removed prior to the haze test. The haze was measured against the background of LCD glass using an UltraScan Pro Spectrophotometer (Hunter Associates Laboratory, Inc., Reston, Va.).

### Method for Color Measurement

Color was measured according to ASTM E1164 07/CIELAB. The results for Adhesive Example 13 are summarized in Table 6. Test specimens were prepared by cleaning LCD glass three times with isopropyl alcohol and completely drying it with KIMWIPES (Kimberly-Clark Corp., Neenah, Wis.). Each OCA film was cut to a size large enough to cover the entrance port of the sphere. The release liner was removed from one side and the OCA film was laminated onto the LCD glass with four passes of a small rubber hand roller. The sample was inspected visually to ensure it was free of visible distinct internal voids, particles, scratches, and blemishes. The second liner was removed prior to the color test. The color was measured against the background of LCD glass using an UltraScan Pro Spectrophotometer (Hunter Associates Laboratory, Inc., Reston, Va.).

### Method for Durability and Anti-Whitening

The release liner was removed from a 2 inch by 3 inch OCA strip and the strip was applied to a 5 mil thick primed poly(ethylene terephthalate) (PET) film (Skyrol SH81, SKC Inc). The OCA strip was secured by four passes of a small rubber hand roller, making sure no air bubbles were entrapped. The second liner was removed from the OCA strip and the OCA strip was laminated onto a 2 inch by 3 inch LCD glass or a 5 mil thick primed PET film. The OCA strip was secured with four passes of a small rubber hand roller, making sure no air bubbles were entrapped. The samples were placed in a testing chamber at 65° C. and 90% relative humidity and checked every other day for the appearance of bubbles or whitening. Formation of bubbles indicated the sample had inadequate durability. For anti-whitening, a sample with visible whitening was removed from the testing chamber and deemed to pass if whitening disappeared within three minutes of removal. The results for Adhesive Example 13 are summarized in Table 6.

### Method for 180 Degree Peel Adhesion Measurement

ASTM D903-98 modified, 180 degree peel, 12 inch/minute. Float glass was cleaned three times with isopropyl alcohol and completely dried with KIMWIPES. An OCA test specimen was cut having dimensions of 1 inch wide by approximately 12 inches long. The release liner was removed from one side and the OCA was laminated to a 2 mil primed PET film with four passes of a small rubber hand roller, making sure no air bubbles were entrapped. The second liner was removed and the OCA secured with three passes of a 5 lb hand roller to float glass, making sure no air bubbles were entrapped. After respectively 20 minutes or 72 hours dwell time at room temperature as specified in Table 6, the 180 degree peel adhesion was measured at a testing speed of 12 inch/minute with an IMASS SP-2000 Slip/Peel Tester (IMASS, Inc, Accord, Mass.).

### Formulations

### Acrylic Copolymer 1

A mixture of 2-EHA/iBOA/HEA=55/25/20 (parts by mass) was prepared and diluted with ethyl acetate/toluene (1:1) to have a monomer concentration of 50 mass %. Then Vazo-52 as an initiator was added in a ratio of 0.15 mass % based on monomer mass. The mixture was charged in a glass bottle and nitrogen purged for 10 minutes, and then sealed while kept in an inert atmosphere. Subsequently, the reaction was allowed to proceed in a constant temperature bath at 55° C. for 6 hours. The reaction temperature was then increased to 75° C. for an additional 4 hrs. A transparent viscous solution was obtained. This acrylic copolymer solution was used in the following Examples without isolation of the copolymer. The weight average molecular weight of the obtained acrylic copolymer was 563,000 g/mol, as measured by gel permeation chromatography vs. polystyrene standard.

### Comparative Example 1

To acrylic copolymer 1, KBM 403 and Desmodur N3300 were added in the ratios of 0.05 and 0.4 mass parts per hundred, respectively, based on dry copolymer mass. Then, the prepared solution was coated on a 50 μm-thick release film RF22N and dried in an oven at 70° C. for 30 minutes. The thickness of the PSA after drying was 50 μm. Subsequently, this PSA surface was laminated with a 50 μm-thick release film RF02N and stored for 24 hrs at 65° C.

### Comparative Example 2

A monomer premix was prepared using Darocur 1173 (0.02 parts), EHA (55 parts), iBOA (25 parts), and HEA (20 parts). This mixture was partially polymerized under a nitrogen-rich atmosphere by exposure to ultraviolet radiation to provide a coatable syrup having a viscosity of about 1000 cps (1 PaS). Then HDDA (0.15 parts), KBM-403 (0.05 parts) and Irgacure 651 (0.15 parts) were added to 100 parts of the syrup. After mixing, it was knife-coated between two silicone-treated release liners (RF02N/RF12N) at a thickness of 50 μm. The resulting coated material was then exposed to a low intensity ultraviolet radiation source having a spectral output from 300-400 nm with a maximum intensity at 351 nm for a total UVA dose of about 2 J/cm².

### Adhesive Example 1

To acrylic copolymer 1, acetyltri-2-ethyl-hexyl citrate, KBM 403 and Desmodur N3300 were added in the ratios of 5, 0.05 and 0.4 mass parts per hundred, respectively, based on the copolymer mass. Then, the prepared solution was coated on a 50 μm-thick release film RF22N and dried in an oven at 70° C. for 30 minutes. The thickness of the PSA after drying was 50 μm. Subsequently, this PSA surface was laminated with a 50 μm-thick release film RF02N and aged for 24 hrs at 65° C.

### Adhesive Example 2

To acrylic copolymer 1, triphenyl phosphine, KBM 403 and Desmodur N3300 were added in the ratios of 5, 0.05 and 0.4 mass parts per hundred, respectively, based on dry copolymer mass. Then, the prepared solution was coated on a 50 μm-thick release film RF22N and dried in an oven at 70° C. for 30 minutes. The thickness of the PSA after drying was 50 μm. Subsequently, this PSA surface was laminated with a 50 μm-thick release film RF02N and aged for 24 hrs at 65° C.

### Adhesive Example 3

To acrylic copolymer 1, hydrocinnamic acid, KBM 403 and Desmodur N3300 were added in the ratios of 5, 0.05 and 0.4 mass parts per hundred, respectively, based on dry copolymer mass. Then, the prepared solution was coated on a 50 μm-thick release film RF22N and dried in an oven at 70° C. for 30 minutes. The thickness of the PSA after drying was 50 μm. Subsequently, this PSA surface was laminated with a 50 μm-thick release film RF02N and aged for 24 hrs at 65° C.

### Adhesive Example 4

To acrylic copolymer 1, Irganox 1076, KBM 403 and Desmodur N3300 were added in the ratios of 1, 0.05 and 0.4 mass parts per hundred, respectively, based on copolymer mass. Then, the prepared solution was coated on a 50 μm-thick release film RF22N and dried in an oven at 70° C. for 30 minutes. The thickness of the PSA after drying was 50 μm. Subsequently, this PSA surface was laminated with a 50 μm-thick release film RF02N and aged for 24 hrs at 65° C.

### Adhesive Example 5

To acrylic copolymer 1, Irganox 1024, KBM 403 and Desmodur N3300 were added in the ratios of 1, 0.05 and 0.4 mass parts per hundred, respectively, based on copolymer mass. Then, the prepared solution was coated on a 50 μm-thick release film RF22N and dried in an oven at 70° C. for 30 minutes. The thickness of the PSA after drying was 50 μm. Subsequently, this PSA surface was laminated with a 50 μm-thick release film RF02N and aged for 24 hrs at 65° C.

### Adhesive Example 6

To acrylic copolymer 1, limonene, KBM 403 and Desmodur N3300 were added in the ratios of 5, 0.05 and 0.4 mass parts per hundred, respectively, based on copolymer mass. Then, the prepared solution was coated on a 50 μm-thick release film RF22N and dried in an oven at 70° C. for 30 minutes. The thickness of the PSA after drying was 50 μm. Subsequently, this PSA surface was laminated with a 50 μm-thick release film RF02N and aged for 24 hrs at 65° C.

### Adhesive Example 7

To acrylic copolymer 1, beta-pinene, KBM 403 and Desmodur N3300 were added in the ratios of 5, 0.05 and 0.4 mass parts per hundred, respectively, based on copolymer mass. Then, the prepared solution was coated on a 50 μm-thick release film RF22N and dried in an oven at 70° C. for 30 minutes. The thickness of the PSA after drying was 50 μm. Subsequently, this PSA surface was laminated with a 50 μm-thick release film RF02N and aged for 24 hrs at 65° C.

### Adhesive Example 8

To acrylic copolymer 1, cinnamyl alcohol, KBM 403 and Desmodur N3300 were added in the ratios of 5, 0.05 and 0.4 mass parts per hundred, respectively, based on copolymer mass. Then, the prepared solution was coated on a 50 μm-thick release film RF22N and dried in an oven at 70° C. for 30 minutes. The thickness of the PSA after drying was 50 μm. Subsequently, this PSA surface was laminated with a 50 μm-thick release film RF02N and aged for 24 hrs at 65° C.

### Adhesive Example 9

To acrylic copolymer 1, cinnamaldehyde, KBM 403 and Desmodur N3300 were added in the ratios of 5, 0.05 and 0.4 mass parts per hundred, respectively, based on copolymer mass. Then, the prepared solution was coated on a 50 μm-thick release film RF22N and dried in an oven at 70° C. for 30 minutes. The thickness of the PSA after drying was 50 μm. Subsequently, this PSA surface was laminated with a 50 μm-thick release film RF02N and aged for 24 hrs at 65° C.

### Adhesive Example 10

To acrylic copolymer 1, cinnamic acid, KBM 403 and Desmodur N3300 were added in the ratios of 5, 0.05 and 0.4 mass parts per hundred, respectively, based on copolymer mass. Then, the prepared solution was coated on a 50 μm-thick release film RF22N and dried in an oven at 70° C. for 30 minutes. The thickness of the PSA after drying was 50 μm. Subsequently, this PSA surface was laminated with a 50 μm-thick release film RF02N and aged for 24 hrs at 65° C.

### Adhesive Example 11

To acrylic copolymer 1, linolenic acid, KBM 403 and Desmodur N3300 were added in the ratios of 5, 0.05 and 0.4 mass parts per hundred, respectively, based on copolymer mass. Then, the prepared solution was coated on a 50 μm-thick release film RF22N and dried in an oven at 70° C. for 30 minutes. The thickness of the PSA after drying was 50 μm. Subsequently, this PSA surface was laminated with a 50 μm-thick release film RF02N and aged for 24 hrs at 65° C.

### Adhesive Example 12

To acrylic copolymer 1, rosin acid, KBM 403 and Desmodur N3300 were added in the ratios of 5, 0.05 and 0.4 mass parts per hundred, respectively, based on copolymer mass. Then, the prepared solution was coated on a 50 μm-thick release film RF22N and dried in an oven at 70° C. for 30 minutes. The thickness of the PSA after drying was 50 μm. Subsequently, this PSA surface was laminated with a 50 μm-thick release film RF02N and aged for 24 hrs at 65° C.

### Adhesive Example 13

A monomer premix was prepared using Darocur 1173 (0.02 parts), EHA (55 parts), iBOA (25 parts), and HEA (20 parts). This mixture was partially polymerized under a nitrogen-rich atmosphere by exposure to ultraviolet radiation to provide a coatable syrup having a viscosity of about 1000 cps (1 PaS). Then HDDA (0.15 part), KBM-403 (0.05 parts), Irganox 1024 (1 part), and Irgacure 651 (0.15 parts) were added to 100 parts of the syrup and after mixing it was knife-coated between two silicone-treated release liners (RF02N/RF12N) at a thickness of 50 p.m. The resulting coated material was then exposed to a low intensity ultraviolet radiation source having a spectral output from 300-400 nm with a maximum intensity at 351 nm for a total UVA dose of about 2 J/cm².

### Adhesive Example 14

A mixture of β-citronellol (300.00 g, 1.92 mol), hexane (1500 mL), and triethylamine (212.49 g, 2.10 mol) was cooled in an ice bath. Acryloyl chloride (190.08 g, 2.10 mol) was added dropwise over 5 hours. The mixture was stirred for 17 hours at room temperature and then filtered. The solution was concentrated under vacuum and washed with water. The solvent was removed under vacuum to provide a crude oil that was purified by vacuum distillation. A colorless oil (282.83 g of citronellyl acrylate) was collected at 70-75° C. at 0.30 mmHg.

A monomer premix was prepared using Darocur 1173 (0.02 parts), EHA (55 parts), iBOA (25 parts), and HEA (20 parts). This mixture was partially polymerized under a nitrogen-rich atmosphere by exposure to ultraviolet radiation to provide a coatable syrup having a viscosity of about 1000 cps (1 PaS). Then HDDA (0.15 part), KBM-403 (0.05 parts), citronellyl acrylate (2 parts), and Irgacure 651 (0.15 parts) were added to 100 parts of the syrup and after mixing it was knife-coated between two silicone-treated release liners (RF02N/RF12N) at a thickness of 50 p.m. The resulting coated material was then exposed to a low intensity ultraviolet radiation source having a spectral output from 300-400 nm with a maximum intensity at 351 nm for a total UVA dose of about 2 J/cm².

TABLE 1
Complexing agents to stabilize silver nanowire

| | | | % Resistance change vs Exposure time, hours | | | | | | | | | | |
|---|---|---|---|---|---|---|---|---|---|---|---|---|---|
| | | | Exposure | Test | | 45 | 100 | 200 | 264 | 300 | 400 | 500 | 516 |
| Samples | Adhesives | Additives | condition | position | Initial | hrs | hrs | hrs | hrs | hrs | hrs | hrs | hrs |
| Conductive | | | A | Light | 0 | | | 12780 | 41956 | | | | |
| film alone | | | | Interface | 0 | | | 241 | 494 | | | | |
| | | | | Dark | 0 | | | 12 | 13 | | | | |
| Comparative | acrylic | | A | Light | 0 | 1 | | | 2 | | | | 2 |
| Example 1 | copolymer 1 | | | Interface | 0 | 2 | | | 48 | | | | 249 |
| | | | | Dark | | | | | | | | | |
| Comparative | acrylic | | B | Light | 0 | | −0.8 | −3.5 | | −18 | 12.6 | 13 | |
| Example 1 | copolymer 1 | | | Interface | 0 | | −0.3 | 2.7 | | −6 | 38 | 171.2 | |
| | | | | Dark | 0 | | −1.4 | −0.2 | | −12 | 12.9 | 21.6 | |
| Adhesive | acrylic | acetyltri-2- | A | Light | 0 | 8 | | | 9 | | | | 7 |
| Example 1 | copolymer 1 | ethyl-hexyl | | Interface | 0 | 7 | | | 11 | | | | 22 |
| | | citrate | | Dark | | | | | | | | | |
| Adhesive | acrylic | H-Cinnamic | B | Light | 0 | | −3 | −2.4 | | −7 | −0.7 | 0.7 | |
| Example 3 | copolymer 1 | acid | | Interface | 0 | | −0.8 | −0.6 | | −5.4 | 0.4 | 12 | |
| | | | | Dark | 0 | | 0.7 | 1.4 | | −2.1 | −1 | 6.6 | |

TABLE 2
Antioxidants to stabilize silver nanowire

| | | % Resistance change vs Exposure time, hours | | | | | | | |
|---|---|---|---|---|---|---|---|---|---|
| | | Exposure | Test | | 45 | 100 | 200 | 264 | 516 |
| Adhesives | Additives | condition | position | Initial | hrs | hrs | hrs | hrs | hrs |

| | | | | | | | | | |
|---|---|---|---|---|---|---|---|---|---|
| Conductive | | | A | Light | 0 | | 12780 | 41956 | |
| film alone | | | | Interface | 0 | | 241 | 494 | |
| | | | | Dark | 0 | | 12 | 13 | |
| Comparative | acrylic | | A | Light | 0 | 1 | | 2 | 2 |
| Example 1 | copolymer 1 | | | Interface | 0 | 2 | | 48 | 249 |
| | | | | Dark | | | | | |
| Adhesive | acrylic | Irganox | A | Light | 0 | 3 | | 2 | −3 |
| Example 4 | copolymer 1 | 1076 | | Interface | 0 | 4 | | 3 | 10 |
| | | | | Dark | | | | | |
| Adhesive | acrylic | Irganox | A | Light | 0 | 1 | | 0 | −2 |
| Example 5 | copolymer 1 | 1024 | | Interface | 0 | 0 | | 1 | 1 |
| | | | | Dark | | | | 0 | 0 |

TABLE 3
Reducing agents to stabilize silver nanowire

| | | | % Resistance change vs Exposure time, hours | | | | | | | | |
|---|---|---|---|---|---|---|---|---|---|---|---|
| | | | Exposure | Test | | 45 | 100 | 200 | 264 | 400 | 516 |
| Samples | Adhesive | Additives | condition | position | Initial | hrs | hrs | hrs | hrs | hrs | hrs |
| Conductive | | | A | Light | 0 | | | 12780 | 41956 | | |
| film alone | | | | Interface | 0 | | | 241 | 494 | | |
| | | | | Dark | 0 | | | 12 | 13 | | |
| Comparative | acrylic | | A | Light | 0 | 1 | | | 2 | | 2 |
| Example 1 | copolymer 1 | | | Interface | 0 | 2 | | | 48 | | 249 |
| | | | | Dark | | | | | | | |
| Adhesive | acrylic | Limonene | A | Light | 0 | 4 | | | 2 | | 2 |
| Example 6 | copolymer 1 | | | Interface | 0 | 4 | | | 5 | | 7 |
| | | | | Dark | | | | | | | |
| Adhesive | acrylic | Triphenyl | A | Light | 0 | 8 | | | 10 | | 10 |
| Example 2 | copolymer 1 | phosphine | | Interface | 0 | 6 | | | 7 | | 9 |
| | | | | Dark | | | | | 5 | | 7 |
| Comparative | acrylic | | B | Light | 0 | | −0.8 | −3.5 | | 12.6 | |
| Example 1 | copolymer 1 | | | Interface | 0 | | −0.3 | 2.7 | | 38 | |
| | | | | Dark | 0 | | −1.4 | −0.2 | | 12.9 | |
| Adhesive | acrylic | Pinene | B | Light | 0 | | 2.5 | 2.2 | | −4.2 | |
| Example 7 | copolymer 1 | | | Interface | 0 | | 2.2 | 2.6 | | −1.7 | |
| | | | | Dark | 0 | | 1.8 | 2.5 | | −2.6 | |

TABLE 4
Reducing, complexing agents to stabilize silver nanowire based sensors

| | | | % Resistance change vs Exposure time, hours | | | | | | | | | | |
|---|---|---|---|---|---|---|---|---|---|---|---|---|---|
| | | | exposure | Test | | 45 | 100 | 200 | 264 | 300 | 400 | 500 | 516 |
| Samples | Adhesive | Additives | condition | position | Initial | hrs | hrs | hrs | hrs | hrs | hrs | hrs | hrs |
| Conductive | | | A | Light | 0 | | | 12780 | 41956 | | | | |
| film alone | | | | Interface | 0 | | | 241 | 494 | | | | |
| | | | | Dark | 0 | | | 12 | 13 | | | | |
| Comparative | acrylic | | A | Light | 0 | 1 | | | 2 | | | | 2 |
| Example 1 | copolymer 1 | | | Interface | 0 | 2 | | | 48 | | | | 249 |
| | | | | Dark | | | | | | | | | |
| Adhesive | acrylic | Linolenic | A | Light | 0 | 3 | | | 3 | | | | 3 |
| Example 11 | copolymer 1 | acid | | Interface | 0 | 0 | | | 2 | | | | 2 |
| | | | | Dark | 0 | | | | −1 | | | | 1 |
| Adhesive | acrylic | Rosin acid | A | Light | 0 | 4 | | | 5 | | | | 6 |
| Example 12 | copolymer 1 | | | Interface | 0 | 2 | | | 13 | | | | 26 |
| | | | | Dark | 0 | | | | | | | | |
| Comparative | acrylic | | B | Light | 0 | | −0.8 | −3.5 | | −18 | 12.6 | 13 | |
| Example 1 | copolymer 1 | | | Interface | 0 | | −0.3 | 2.7 | | −6 | 38 | 171.2 | |
| | | | | Dark | 0 | | −1.4 | −0.2 | | −12 | 12.9 | 21.6 | |
| Adhesive | acrylic | Cinnamyl | B | Light | 0 | | 0.75 | 1.5 | | −2.3 | −2 | 1.1 | |
| Example 8 | copolymer 1 | alcohol | | Interface | 0 | | −0.5 | 1.6 | | −2.9 | 0.2 | 8.5 | |
| | | | | Dark | 0 | | −1.2 | 0.1 | | −4.7 | 0.4 | 8.2 | |
| Adhesive | acrylic | Cinnamic | B | Light | 0 | | −0.4 | −0.7 | | −8.6 | −1 | | |
| Example 9 | copolymer 1 | aldehyde | | Interface | 0 | | −1 | 0.5 | | −5.7 | 0.9 | | |
| | | | | Dark | 0 | | −1.2 | 0.6 | | −7.4 | −0.5 | | |
| Adhesive | acrylic | Cinnamic | | Light | 0 | | 3.2 | 4 | | −1 | −1 | 3.5 | |
| Example 10 | copolymer 1 | acid | B | Interface | 0 | | 3.3 | 3.8 | | −1 | −0.9 | 3 | |
| | | | | Dark | 0 | | 4 | 3.8 | | −2.5 | −1.8 | 4.3 | |

TABLE 5
UV polymerized polymer with additives to stabilize metal sensors

| | | % Resistance change vs Exposure time, hours | | | | | | | | | |
|---|---|---|---|---|---|---|---|---|---|---|---|
| | | Exposure | Test | | 45 | 100 | 200 | 264 | 300 | 400 | 516 |
| Samples | Additives | condition | position | Initial | hrs | hrs | hrs | hrs | hrs | hrs | hrs |
| Conductive | | A | Light | 0 | | | 12780 | 41956 | | | |
| film alone | | | Interface | 0 | | | 241 | 494 | | | |
| | | | Dark | 0 | | | 12 | 13 | | | |
| Comparative | | A | Light | 0 | 1 | | | 2 | | | 2 |
| Example 2 | | | Interface | 0 | 2 | | | 48 | | | 249 |
| | | | Dark | | | | | | | | |
| Comparative | | B | Light | 0 | | −1 | −3.4 | | −15 | 12 | |
| Example 2 | | | Interface | 0 | | −0.3 | 2.6 | | −5 | 40 | |
| | | | Dark | 0 | | −1.5 | −0.2 | | −11 | 12 | |
| Adhesive | Irganox | B | Light | 0 | | −1.3 | −4.8 | | −15.7 | −7.7 | |
| Example 13 | 1024 | | Interface | 0 | | −2.2 | −2.7 | | −11 | 2.8 | |
| | | | Dark | 0 | | −1.6 | −1 | | −7.7 | −0.3 | |
| Adhesive | Citronellyl | B | Light | 0 | | 2.3 | 1.9 | | −13.1 | −7.3 | |
| Example 14 | acrylate | | Interface | 0 | | 1.3 | 2.7 | | −10.5 | −6 | |
| | | | Dark | 0 | | −2.1 | 2.7 | | −10.3 | 0 | |

TABLE 6
Physical properties and performance characteristics
for Adhesive Example 13

| | | | Results for |
|---|---|---|---|
| Testing | | | Adhesive 13 |
| Durability(65° C./90% RH, | | 5 mil PET/5 mil PET | No bubble |
| 14 days) | | 5 mil PET/LCD Glass | No bubble |
| Anti-whitening(65° C./90% RH, | | 5 mil PET/5 mil PET | Good |
| 14 days) | | 5 mil PET/LCD Glass | Good |
| Optics | Yellowing, b* | | 0.18 |
| | Haze % | | 0.16 |
| | Transmittance % (350-800 nm) | | 91.8 |
| | Transmittance % (400-800 nm) | | 92.3 |
| 180 degree peel | Float glass | 20 min dwell | 83 |
| Adhesion (peel rate | | 72 hour dwell | 79 |
| 12 ipm, units oz/in) | PET | 20 min dwell | 57 |
| | | 72 hour dwell | 58 |
| | PMMA | 20 min dwell | 66 |
| | | 72 hour dwell | 68 |
| | PC | 20 min dwell | 70 |
| | | 72 hour dwell | 74 |

Although the present invention has been described with reference to preferred embodiments, workers skilled in the art will recognize that changes may be made in form and detail without departing from the spirit and scope of the invention.

What is claimed is:

1. An adhesive composition for stabilizing an electrical conductor comprising:
a base polymer; and
an additive to interfere with photo-oxidation of metals;
wherein when the adhesive composition is in contact with the electrical conductor, the electrical conductor has less than about a 20% change in electrical resistance over a period of about 500 hours of light exposure.

2. The adhesive composition of claim 1, wherein the additive is selected from the group consisting of: metal complexing materials, anti-oxidants, reducing agents, metal complexing and reducing materials and combinations thereof.

3. The adhesive composition of claim 1, wherein the additive comprises up to about 5% by weight of the adhesive composition.

4. The adhesive composition of claim 1, wherein the additive comprises at least at about 0.1% by weight of the adhesive composition.

5. The adhesive composition of claim 1, wherein the additive comprises between about 0.5 and about 3% by weight of the adhesive composition.

6. The adhesive composition of claim 1, wherein the base polymer comprises one of a polyester, polyurethane, polyurea, polyamide, silicone, polyolefin, acrylic block copolymer, rubber block copolymer or random (meth)acrylic copolymer.

7. The adhesive composition of claim 6, wherein the base polymer is a random (meth)acrylic copolymer.

8. The adhesive composition of claim 1, wherein the electrical conductors are based on metallic conductors.

9. The adhesive composition of claim 8, wherein the metallic conductors comprise silver or copper.

10. The adhesive composition of claim 8, wherein the metallic conductors are metallic nanoparticles, nanorods and nanowires.

11. The adhesive composition of claim 1, further comprising a crosslinker.

12. The adhesive composition of claim 1, wherein when the adhesive composition is coated on the electrical conductor, the electrical conductor has less than about a 10% change in electrical resistance over a period of about 500 hours of light exposure.

13. A method of stabilizing an electrical conductor comprising:
providing an adhesive composition comprising:
a base polymer; and
an additive for interfering with or preventing oxidation of the electrical conductor; and
coating or laminating the adhesive composition on the electrical conductor;
wherein when the adhesive composition is coated on the electrical conductor, the electrical conductor has less than about a 20% change in electrical resistance over a period of about 500 hours of light exposure.

14. The method of claim 13, wherein the additive is selected from the group consisting of: metal complexing materials, anti-oxidants, reducing agents, metal complexing and reducing materials and combinations thereof.

15. The method of claim 13, wherein the additive comprises between about 0.1 and about 5% by weight of the adhesive composition.

16. The method of claim 13, wherein the base polymer comprises one of a polyester, polyurethane, polyurea, polyamide, silicone, polyolefin, acrylic block copolymer, rubber block copolymer or random (meth)acrylic copolymer.

17. The method of claim 13, wherein the electrical conductors are based on metallic conductors.

18. The adhesive method of claim 17, wherein the metallic conductors are metallic nanoparticles, nanorods and nanowires.

19. The method of claim 13, further comprising a crosslinker.

20. The method of claim 13, wherein when the adhesive composition is coated or laminated on the electrical conductor, the electrical conductor has less than about a 10% change in electrical resistance over a period of about 500 hours of light exposure.
